(19) United States
(12) Patent Application Publication
(10) Pub. No.: US 2005/0041952 A1
(43) Pub. Date: Feb. 24, 2005

(54) Digital video recorder system with mobile monitor

(76) Inventor: Sang-Keun Ko, Seoul (KR)

Correspondence Address: Robert E. Bushnell, Suite 300, 1522 K Street, N.W., Washington, DC, 20005, US

(21) Appl. No.: 10/902,784

(22) Filed: Aug. 2, 2004

(30) Foreign Application Priority Data
Aug. 2, 2003 (KR) 2003-53610

(51) Int. Cl. H04N 5/76; H04N 5/781

(52) U.S. Cl. 386/46; 386/125

(57) ABSTRACT

Disclosed is a digital video recorder system. A digital video recorder and a mobile monitor are interconnected by one connector cable since a pair of connectors is installed thereto. The mobile monitor has a control panel, and a control signal generated from the control panel is input to the digital video recorder by means of the connector cable. Several external devices connected to the digital video recorder are rapidly connected at a time through a wire harness connector cable. The digital video recorder system may allow a plurality of external I/O devices such as video camera and alarm device to be rapidly connected to the digital video recorder at a time, and the entire system may be effectively operated and managed with one mobile monitor under the circumstance that several digital video recorders should be distributed to several spots.

### BACKGROUND OF THE INVENTION

1. Field of the Invention

The present invention relates to a digital video recorder system, and more particularly to a digital video recorder system capable of rapidly connecting several external devices to a digital video recorder at a time and provided with a mobile monitor having a control panel for controlling the digital video recorder.

2. Description of the Related Art

A video recorder system is widely used in industrial installations, large buildings and public facilities for the management of safety, security and environment. A conventional video recorder system is an analog system, which uses a magnetic tape as an image storage medium. The analog video recorder system using a magnetic tape has several drawbacks. For example, when the magnetic tape is repeatedly used several times, quality of image is deteriorated due to the inherent features of the magnetic tape, and the magnetic tape is not suitable for fast image search and does not allow easy editing and storing. In addition, since the magnetic tape has a strictly limited storage capacity, several video recorders are required to configure one system when it is needed to record for a long time.

As the computer-related technologies are developed, a digital mass-storage medium for storing a large amount of data is also developed together. For example, a storage capacity of a hard disk drive is initially several to several ten megabytes and recently reaches several to several hundred gigabytes. The conventional analog video recorder is being substituted with a digital video recorder using such a digital mass-storage medium. The digital video recorder overcomes several drawbacks of the analog video recorder and also gives various advantages. For example, only one mass-storage hard disk ensures recording for a long time, and if recording for longer time is required, it is sufficient just to increase the storage capacity. In addition, since all data are stored in digital method, searching and editing are easier than the analogy method.

Generally, a digital video recorder is provided in a way that a hard disk drive is loaded in a main body or detachably mounted therein. The digital video recorder has a plurality of I/O terminals such as a video I/O terminal, an alarm I/O terminal or the like for connection to external devices such as a video camera, an alarm device or a display monitor, and the I/O terminals are mounted to a rear panel of the main body. In addition, a plurality of control buttons for controlling various functions of the video recorder are provided on a front panel of the main body.

Recently, the digital video recorder is applied to a vehicle supervision system of buses or trains. The digital video recorder loaded in each vehicle records a state of the vehicle during the service time. However, since various external devices should be connected to the digital video recorder one by one in order to load the digital video recorder in a vehicle, its installation procedure is very complicated and troublesome. In addition, a separate monitoring system is required for a manager to examine the service record.

### SUMMARY OF THE INVENTION

The present invention is designed in consideration of such drawbacks of the prior art, and it is an object of the present invention to provide a digital video recorder system with a mobile monitor, which is capable of facilitating installation of external devices to a digital video recorder and having a mobile monitor for controlling the digital video recorder and monitoring a recorded image.

In order to accomplish the above object, the present invention provides a digital video recorder system, which includes a digital video recorder for receiving an image signal from outside and recording the image signal in a digital storage medium; and a mobile monitor including a control panel composed of a plurality of switch buttons for controlling the digital video recorder and a display panel for displaying an image so as to regenerate and monitor the image recorded in the digital storage medium wherein a pair of connectors are installed to the digital video recorder and the mobile connector so that the digital video recorder and the mobile connector are interconnected by one connector cable, and a control signal generated from the control panel is input to the digital video recorder by means of the connector cable.

In this embodiment, the digital storage medium is preferably composed of a hard disk drive, and the hard disk drive may be loaded in a movable carrier and then detachably installed to a fixed frame mounted to a main body of the digital video recorder.

In this embodiment, the digital video recorder preferably has one wire harness connector for connection to a plurality of external devices, and is connected to the external devices by means of a wire harness connector cable.

In this embodiment, a handle is preferably mounted to an outside of the mobile monitor and used for carrying the mobile monitor.

In this embodiment, the mobile monitor is preferably provided with an operating power through the connector cable from the digital video recorder.

In this embodiment, the mobile monitor preferably includes an additional connector for connection to a computer system, and operates in connection with an application program for the digital video recorder, loaded in the computer system.

### BRIEF DESCRIPTION OF THE DRAWINGS

Other objects and aspects of the present invention will become apparent from the following description of embodiments with reference to the accompanying drawing in which:

FIG. 1 is a perspective view showing a digital video recorder system according to the present invention;

FIG. 2 is a perspective view showing a digital video recorder of FIG. 1;

FIG. 3 is a perspective view showing a mobile monitor of FIG. 1; and

FIG. 4 is a block diagram showing circuitry of the digital video recorder system according to the present invention.

### DETAILED DESCRIPTION OF THE PREFERRED EMBODIMENT

Hereinafter, preferable embodiments of the present invention will be described in more detail referring to the drawings. However, the present invention is not limited to the following embodiments, and may be specified in other ways within the scope of the invention. The embodiments introduced herein are provided just for disclosing the invention more thoroughly and more perfectly, and so that the spirit of the invention is more sufficiently understood by those ordinarily skilled in the art.

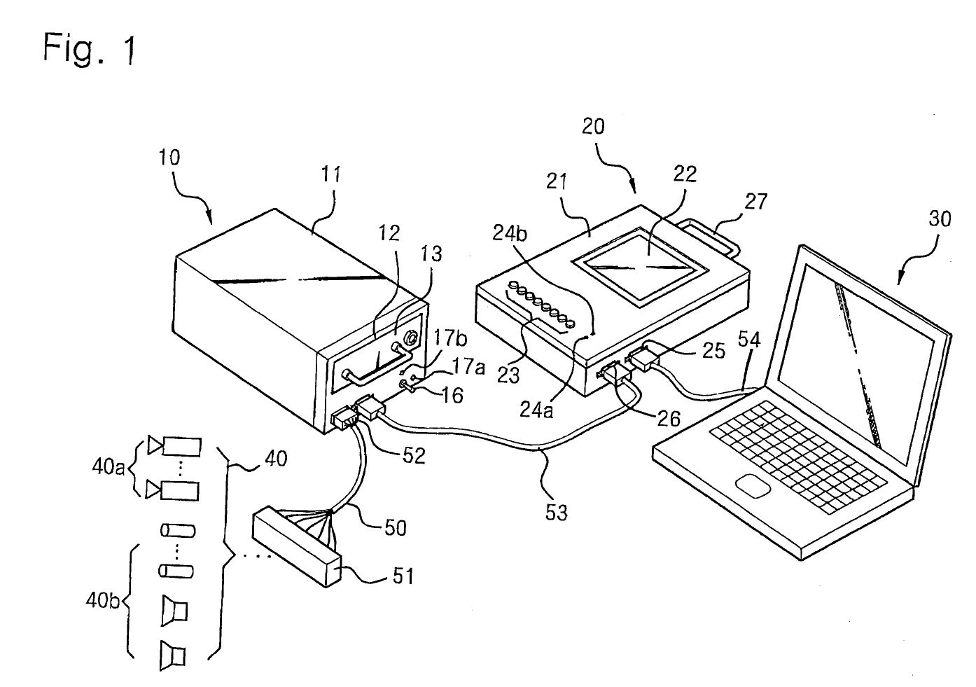

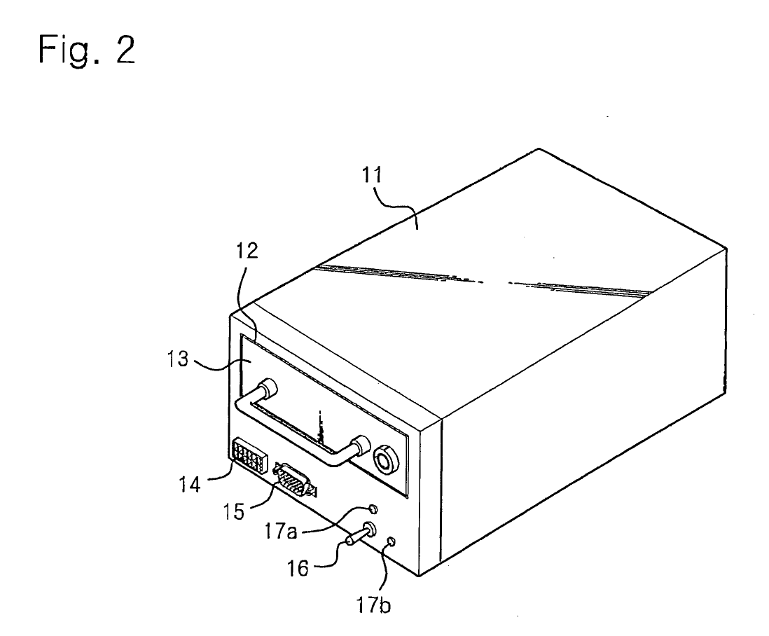

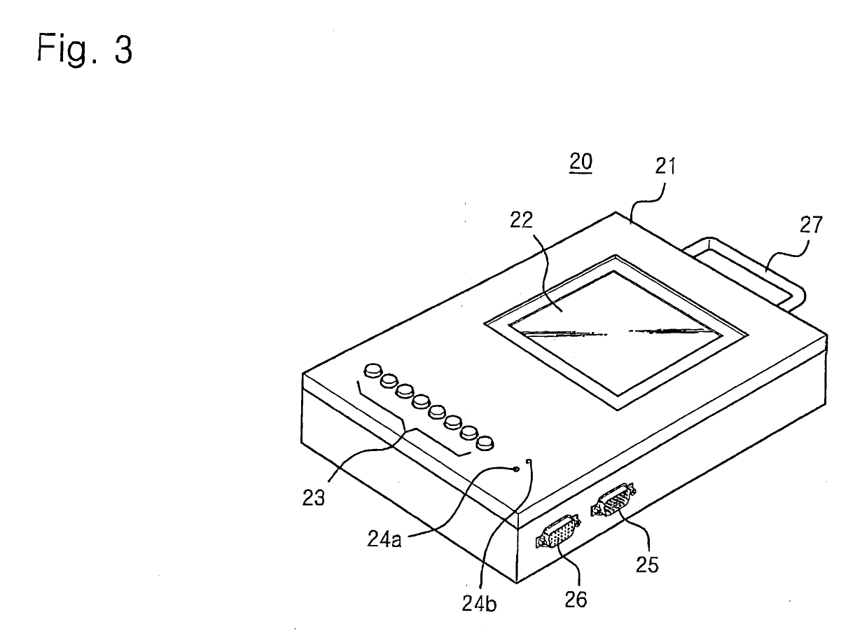

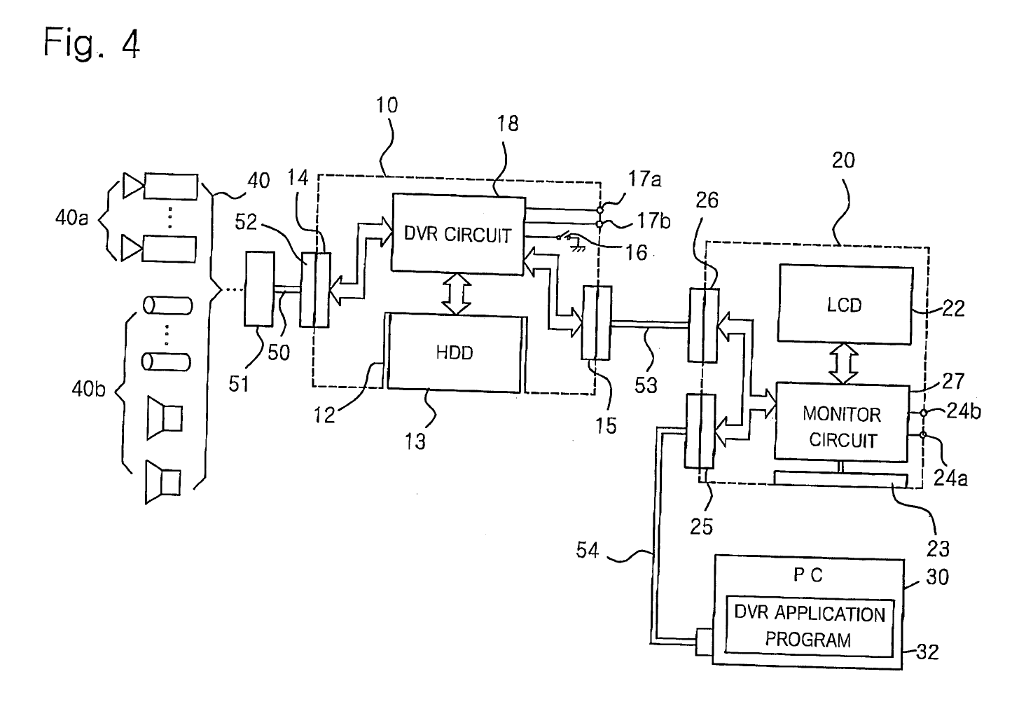

FIG. 1 shows a connection structure of a digital video recorder system according to the present invention, and FIGS. 2 and 3 show an appearance of a digital video recorder of FIG. 1 in detail. In addition, FIG. 4 is a block diagram showing circuitry of the digital video recorder system according to the present invention.

Referring to FIGS. 1 to 4, the digital video recorder system of the present invention includes, in brief, a digital video recorder 10 and a mobile monitor 20. The digital video recorder 10 receives an image signal from outside and records it in a digital storage medium, and also regenerates the recorded digital image. The mobile monitor 20 includes a control panel 23 composed of a plurality of switch buttons for controlling the digital video recorder 10 and a display panel for displaying an image, and regenerates and monitors the image recorded in the digital storage medium.

More specifically, a main body housing 11 of the digital video recorder 10 has a fixed frame 12 with a front opening, and a movable carrier 13 to which a hard disk drive is mounted is detachably mounted therein. First and second connectors 14 and 15 are installed at a lower front end of the main body housing 11, and a power switch 16 is provided at one side. In addition, indication lamps 17a and 17b are installed to the main body housing 11 in order to indicate a power supply state and an operation state of the hard disk drive, respectively.

The first connector 14 installed on the front surface of the main body housing 11 is a wire harness connector, so it is rapidly connected to a plurality of external devices at a time through a wire harness connector cable 50. The wire harness connector cable 50 is configured so that one end has one connector 52 coupled with the first connector 14 and the other end has another connector 51 connected to a plurality of external devices 40. The external devices 40 are, for example, a plurality of video cameras 40a and a plurality of alarm I/O devices 40b. Though not shown in the figures, it is possible to supply an operation power of the digital video recorder 10 through the connector 51 at the other end of the wire harness connector cable 50.

A digital video recorder circuit 18 of the digital video recorder 10 receives video signals of various channels through the wire harness connector cable 50 and then records the video signals in the hard disk drive 13, and it is also connected with several alarm I/O devices 40b for input or output of an alarm signal.

The display panel 22 for displaying images is installed to the front surface of a monitor circuit in the mobile monitor 20, and the control panel 23 composed of a plurality of switch buttons and the indication lamps 24a and 24b are installed in a lower portion of the mobile monitor 20. In addition, two connectors 25 and 26 are installed to one side of the mobile monitor 20, and a handle 27 used for carrying the mobile monitor 20 is installed at an upper end of the mobile monitor 20. One connector 26 installed to the side of the mobile monitor 20 is coupled with the second connector 15 installed to the front side of the main body housing 11, and they are interconnected by means of one connector cable 53. The other connector 25 is connected to a computer system 30 such as a laptop computer or a desktop computer through the connector cable 54.

The mobile monitor 20 is connected to the digital video recorder 10 through the connector cable 53, so it receives image signals of at least one channel and then displays image on the display panel 22, and the mobile monitor 20 also inputs an input signal of the control panel 23 to the digital video record circuit 18. The mobile monitor 20 is also connected to the computer system 30 through the connector cable 54, so it operates in connection with an application program 32 for the digital video recorder, loaded in the computer system 30. The mobile monitor 20 may be provided with an operating power from the digital video recorder 10 through the connector cable 53.

The aforementioned digital video recorder system of the present invention may be more effective in a circumstance that several digital video recorders should be distributed to several spots. For example, in case of a transportation company managing several vehicles, the digital video recorder system of the present invention may be effectively used to monitor service states of the vehicles.

That is to say, the digital video recorder 10 is installed to each vehicle, and then a manager may monitor the images recorded in the digital video recorders 10 in the vehicles with the use of the mobile monitor 20, moving vehicle by vehicle. In case the digital video recorder 10 and the mobile monitor 20 are connected for monitoring, they may be simply connected by using one connector cable 53, and each function of the digital video record 10 may be controlled with the use of the control panel 23 provided in the mobile monitor 20.

When the digital video recorder 10 is installed in the vehicle, an earthquake-proof case may be additionally used. In addition, many external devices such as a plurality of video cameras, a plurality of alarm I/O devices and a power supply terminal may be easily connected to the digital video recorder 10 by means of one wire harness connector cable 50.

Configuration and operation of the digital video recorder system with a mobile monitor according to the present invention have been described and illustrated with reference to the accompanying drawings, but the above description is just an example, and various changes and modifications will be obviously possible within the range, not departing from the technical aspect of the present invention.

As mentioned above in detail, the digital video recorder system according to the present invention is capable of allowing a plurality of external I/O devices such as video camera and alarm device to be rapidly connected to a digital video recorder at a time. In addition, the digital video recorder system of the present invention gives convenience to users since the entire system may be effectively operated and managed with one mobile monitor under the circumstance that a plurality of digital video recorders should be distributed to several spots.

1. A digital video recorder system, comprising:
a digital video recorder for receiving an image signal from outside and recording the image signal in a digital storage medium; and
a mobile monitor including a control panel composed of a plurality of switch buttons for controlling the digital video recorder and a display panel for displaying an image so as to regenerate and monitor the image recorded in the digital storage medium,
wherein a pair of connectors are installed to the digital video recorder and the mobile connector so that the digital video recorder and the mobile connector are interconnected by one connector cable, and a control signal generated from the control panel is input to the digital video recorder by means of the connector cable.

2. The digital video recorder system according to claim 1,
wherein the digital storage medium is composed of a hard disk drive, and the hard disk drive is loaded in a movable carrier and then detachably installed to a fixed frame mounted to a main body of the digital video recorder.

3. The digital video recorder system according to claim 1,
wherein the digital video recorder has one wire harness connector for connection to a plurality of external devices, and is connected to the external devices by means of a wire harness connector cable.

4. The digital video recorder system according to claim 1,
wherein a handle is mounted to an outside of the mobile monitor and used for carrying the mobile monitor.

5. The digital video recorder system according to claim 1,
wherein the mobile monitor is provided with an operating power through the connector cable from the digital video recorder.

6. The digital video recorder system according to claim 1,
wherein the mobile monitor includes an additional connector for connection to a computer system, and operates in connection with an application program for the digital video recorder, loaded in the computer system.

7. A digital video recorder system, comprising:
a main body housing of a digital video record in which a digital video recorder circuit and a digital storage medium are loaded and to which first and second connectors are mounted;
a wire harness connector cable at one end of which one connector coupled with the first connector is provided and at the other end of which the other connector is provided for connection to a plurality of external devices; and
a mobile monitor having one connector coupled with the second connector, the mobile monitor including a control panel composed of a plurality of switch buttons for controlling the digital video recorder and a display panel installed on a front side thereof for display an image,
wherein the digital video connector and the mobile monitor are interconnected by means of the second connector and the connector coupled with the second connector through one connector cable, and a control signal generated from the control panel is input to the digital video recorder by means of the connector cable.

8. The digital video recorder system according to claim 7,
wherein the digital storage medium is composed of a hard disk drive, and the hard disk drive is loaded in a movable carrier and then detachably mounted to a fixed frame mounted to the main body housing of the digital video recorder.

9. The digital video recorder system according to claim 7,
wherein a handle is mounted to an outside of the mobile monitor and used for carrying the mobile monitor.

10. The digital video recorder system according to claim 7,
wherein the mobile monitor is provided with an operating power through the connector cable from the digital video recorder.

11. The digital video recorder system according to claim 7,
wherein the mobile monitor includes an additional connector for connection to a computer system, and operates in connection with an application program for the digital video recorder, loaded in the computer system.
